(19) United States
(12) Patent Application Publication
(10) Pub. No.: US 2010/0149190 A1
(43) Pub. Date: Jun. 17, 2010

(54) METHOD, APPARATUS AND COMPUTER PROGRAM PRODUCT FOR PROVIDING AN INPUT ORDER INDEPENDENT CHARACTER INPUT MECHANISM

(75) Inventors: Qifeng Yan, Espoo (FI); Kongqiao Wang, Beijing (CN); Yingfei Liu, Beijing (CN); Kun Yu, Beijing (CN); Jianwei Niu, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/332,955

(22) Filed: Dec. 11, 2008

(51) Int. Cl. G06F 3/02; G06T 11/00

(52) U.S. Cl. 345/467; 345/171

(57) ABSTRACT

An apparatus for providing an input order independent character input mechanism may include a processor. The processor may be configured to receive an input comprising an element corresponding to a portion of a character being entered by a user independent of an order for inputting the element based on the portion of the character corresponding to the element, wherein receiving an input comprises receiving at least one radical. The processor may additionally be configured to retrieve at least one candidate character for the character being entered based at least in part on the received element. The processor may also be configured to provide a selection of candidate characters including the at least one candidate character to the user. Associated methods and computer program products may also be provided.

### TECHNOLOGICAL FIELD

Embodiments of the present invention relate generally to user interface technology and, more particularly, relate to a method, apparatus and computer program product for providing an input order independent character input mechanism.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the usability of a user interface with respect to communication or media applications desired by the user, such as short messages, an electronic book, email, content sharing, web browsing, a music player, a game player, etc.

A user interface may be provided to enable receipt of user input at the device and provision of output to the user. The user interface may be utilized for text input, for selection of commands, options, hotspots, etc., and for numerous other functions. A typical user interface may include a keyboard or keypad including keys that may be pressed or selected in order to provide character entry. The keyboard may be physically embodied, for example, as a plurality of keys having a predefined function associated therewith, or may be embodied in software (e.g., via a touch screen or a keyboard rendered on a display with keys selectable by mouse or scrolling device). However, regardless of whether a touch screen, rendered keyboard or physical keyboard is utilized, for certain electronic devices in which the size of the device may be limited for practical or personal reasons, it may be difficult to provide text entry in an efficient or expeditious manner, especially with respect to entry of Asian characters and other types of complex characters. Accordingly, improvements for a character input mechanism may be desirable.

### BRIEF SUMMARY

A method, apparatus and computer program product are therefore provided according to one embodiment to enable the provision of an input order independent character input mechanism. In this regard, some embodiments of the present invention may provide a character input mechanism that is not dependent on the order (e.g., input order) of the elements of the characters. For example, some embodiments of the present invention may be tailored to provide candidates for completion of characters for which at least one element is entered independent of a conventional or predetermined order for entering the element to complete the character. As such, a user may no longer have to remember or memorize the order of inputting the elements of a character. The provided candidates may be ordered according to their frequency of usage (e.g., decreasing order of frequency of usage in text entry applications such as short messages). Accordingly, as additional elements of the character are inputted, the selection of candidate characters may be adjusted, and as such, the likelihood (e.g., probability) of the character being provided and thus selected from amongst the candidates may increase. Therefore, embodiments of the present invention may provide improvements (e.g., efficiency, speed, number of input events, ease, and/or the like) with respect to the input of characters over existing stroke input methods because the order for inputting or writing elements of characters need not be strictly adhered to when inputting characters.

Embodiments of the present application may also provide a touch screen device which may be employed in conjunction with a stylus, a pen, pencil or other pointing device that may be substituted for a dedicated instrument to function as a stylus (e.g., a finger). The touch screen device may facilitate the knowledge of character input key press, and as such, embodiments of the present invention may enable single-handed character input (e.g., via interactions of a finger with the touch screen). Accordingly, user experience in the input of characters may be enhanced.

In an exemplary embodiment, a method of providing an input order independent character input mechanism is provided. The method may include receiving an input comprising an element corresponding to a portion of a character being entered independent of an order for inputting the element based on the portion of the character corresponding to the element, wherein receiving an input comprises receiving at least one radical, retrieving at least one candidate character for the character being entered based at least in part on the received element, and providing a selection of candidate characters including the at least one candidate character to the user.

In another exemplary embodiment, a computer program product for providing an input order independent character input mechanism is provided. The computer program product includes at least one computer-readable storage medium having computer-executable program code instructions stored therein. The computer-executable program code instructions may include program code instructions for receiving an input comprising an element corresponding to a portion of a character being entered independent of an order for inputting the element based on the portion of the character corresponding to the element, wherein receiving an input comprises receiving at least one radical, program code instructions for retrieving at least one candidate character for the character being entered based at least in part on the received element, and program code instructions for providing a selection of candidate characters including the at least one candidate character to the user.

In another exemplary embodiment, an apparatus for providing an input order independent character input mechanism is provided. The apparatus may include a processor. The processor may be configured receive an input comprising an element corresponding to a portion of a character being entered independent of an order for inputting the element based on the portion of the character corresponding to the element, wherein receiving an input comprises receiving at least one radical, retrieve at least one candidate character for the character being entered based at least in part on the received element, and provide a selection of candidate characters including the at least one candidate character to the user.

In another exemplary embodiment, an apparatus for providing an input order independent character input mechanism is provided. The apparatus may include means for receiving an input comprising an element corresponding to a portion of a character being entered independent of an order for inputting the element based on the portion of the character corresponding to the element, wherein receiving an input comprises receiving at least one radical, means for retrieving at least one candidate character for the character being entered based at least in part on the received element, and means for providing a selection of candidate characters including the at least one candidate character to the user.

Embodiments of the invention may provide a method, apparatus and computer program product for employment in mobile environments, such as on a mobile terminal capable of rendering content items related to various types of media, and in fixed environments. As a result, for example, users may enjoy an improved ability to input character and/or text for communication, work product generation, entertainment, instructional or other purposes, and a corresponding improved user interface capability.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of an apparatus for providing an input order independent character input mechanism according to an exemplary embodiment of the present invention;

FIG. 3 illustrates an exemplary framework for providing an input order independent character input mechanism according to an exemplary embodiment of the present invention;

FIG. 4 illustrates an example of a user interface display for providing an input order independent character input mechanism in accordance with an exemplary embodiment of the present invention;

FIGS. 5A-C illustrate exemplary user interface displays providing an exemplary method for an input order independent input character mechanism in accordance with an exemplary embodiment of the present invention;

FIG. 6 illustrates an exemplary embodiment of an extended input event functionality; and

FIG. 7 is a flowchart according to an exemplary method for providing an input order independent input character mechanism according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

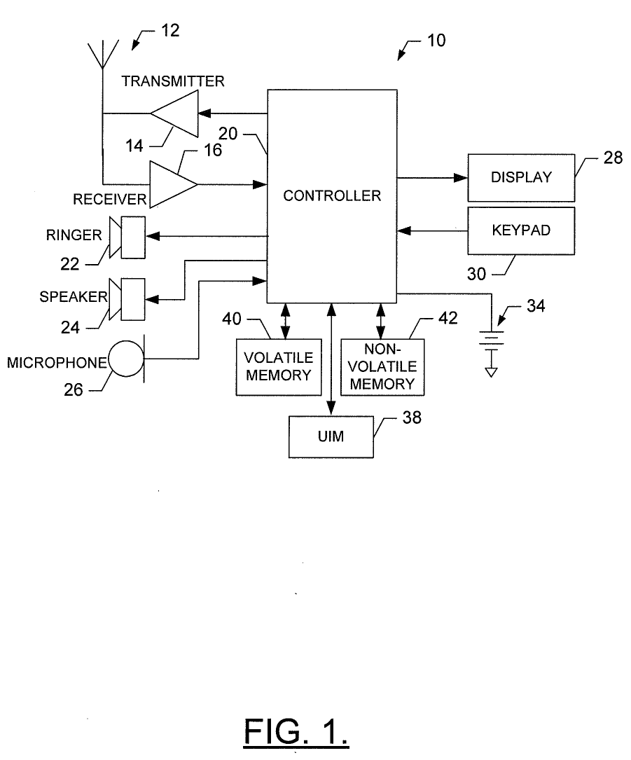

FIG. 1 illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, global positioning system (GPS) devices, mobile telephones, any combination of the aforementioned, and/or other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 may include an antenna 12 (or multiple antennas) in operable communication with a transmitter 14 and a receiver 16. The mobile terminal 10 may further include an apparatus, such as a controller 20 or other processing element, that may provide signals to and receive signals from the transmitter 14 and receiver 16, respectively. The signals may include signaling information in accordance with the air interface standard of the applicable cellular system, and/or may also include data corresponding to speech, received data and/or user generated/transmitted data. In this regard, the mobile terminal 10 may be capable of operating with one or more air interface standards, communication protocols, modulation types, and access types. As an alternative (or additionally), the mobile terminal 10 may be capable of operating in accordance with non-cellular communication mechanisms. For example, the mobile terminal 10 may be capable of communication in a wireless local area network (WLAN) or other communication networks.

The controller 20 may include circuitry implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 may be allocated between these devices according to their respective capabilities. The controller 20 may also support other functionality for use in encoding, receiving and/or transmitting messages. Further, the controller 20 may include functionality to operate one or more software programs, which may be stored in memory. For example, the controller 20 may be capable of operating a connectivity program, such as a conventional web browser. The connectivity program may then allow the mobile terminal 10 to transmit and receive web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a microphone 26, a display 28, and a user input interface, which may be operationally coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include characters (e.g., multi-element characters such as Asian characters) and other hard and soft keys used for operating the mobile terminal 10. Additionally or alternatively, the keypad 30 may include a numeric (0-9), related keys (#, *), and/or a QWERTY keypad arrangement. The keypad 30 may also include various soft keys with associated functions. In addition, or alternatively, the mobile terminal 10 may include an interface device such as a joystick or other user input interface. The mobile terminal 10 may further include a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 can additionally or alternatively comprise an electrically erasable programmable read only memory (EEPROM), flash memory, other non-volatile RAM (NVRAM) or the like. Non-volatile memory 40 may also include a cache area for the temporary storage of data. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

As used herein, the term “character” may be used to refer to letter, symbol, number, and/or the like. A character may contain or comprise of one or more elements such as, for examples, one or more radicals and/or one or more strokes. Similarly a radical may comprise one or more elements (e.g., one or more strokes). As such, a character may entirely comprise one or more strokes. The term “radical” may be used to refer to an element such as, for example, a semantic element (e.g., a semantic root) or other portion of a character. A radical may be an element of one or more characters. The terms “word” or “words” as used herein may refer to character sequences that may or may not be present in a dictionary including, for example, phrases, slang, abbreviations, emoticons, acronyms, etc.

Exemplary embodiments of the present invention generally provide a method, apparatus and computer program product to enable the provision of an input order independent character input mechanism. In this regard, some embodiments of the present invention may provide a multi-element character input mechanism (e.g., for short messages) that is not dependent on the order (e.g., input order or writing) of the elements of the characters. For example, some embodiments of the present invention may be tailored to provide candidates for completion of multi-element characters (e.g., for short messages) for which at least one element (e.g., radical or stroke) is entered independent of a conventional or predetermined order for entering the element to complete the character. Accordingly, the user may not be required to enter each element (e.g., radical or stroke) of the character in a conventional or predetermined order. Candidate characters may be retrieved from a database or table storing a plurality of characters and a selection of the retrieved candidate characters may be provided to the user (e.g., in a list). The candidate characters may be retrieved based at least in part on the entered element (e.g., radical or stroke), or in other words, the retrieved candidate characters may each contain the entered element. The provided candidate characters may be ordered according to their frequency of usage either generally or the current context (e.g., decreasing order of frequency of usage in text entry applications such as short messages). As additional elements of the character are inputted, the selection of candidate characters may be adjusted based at least in part on the additionally inputted elements. In this regard, the selection of candidate characters may be modified to remove the candidate character(s) not containing the additionally inputted element(s). As such, the likelihood (e.g., probability) of the character being provided and thus selected from amongst the candidates may increase. Accordingly, the number of inputs which may be required to enter a character may be significantly decreased (e.g. by permitting selection of the character from the candidates prior to input each element of the character).

Embodiments of the present invention may enable a user to input characters in a number of different manners. It should be understood some characters (e.g., Asian characters) are multi-element characters which require each element to be inputted in a predetermined or conventional order. Nevertheless, as mentioned herein, embodiments of the present invention may enable a user to input the elements of multi-element characters in an arbitrary order, or in other words, independent of a conventional order for inputting the elements of the characters. In one example, a user may input a character by inputting a combination of one or more radicals and one or more strokes, independent of the conventional order of inputting or writing the radicals or strokes comprising the character. For instance, the first inputted element may be a radical followed by the input(s) of one or more radicals and/or strokes in varying orders. In another example, a user may input a character by inputting one or more radicals, independent of the conventional order of inputting or writing the radicals comprising the character. In yet another example, a user may input a character by inputting a combination of one or more strokes and one or more radicals. For instance, a user may first input one or more strokes and subsequently input a radical followed by a combination of one or more radicals and/or one or more strokes in varying orders. In this regard, the strokes inputted before the first radical may be inputted in order, or other words may correspond to the first stroke(s) of the character. Nevertheless, the first subsequent radical input and other subsequent element(s) (e.g., radical(s) and/or stroke(s)) may be entered independent of the conventional order of inputting or writing the radical(s) or stroke(s) comprising the character. In yet another example, a user may input a character by input one or more strokes, dependent or otherwise based on of the conventional order of inputting or writing the strokes comprising the character.

Accordingly, embodiments of the present invention may enable a conventional stroke input method (e.g., input order dependent) individually, or in combination with the embodiments of the present invention. As such, a user may no longer have to remember or memorize the order of inputting or writing the elements of a character. Therefore, embodiments of the present invention may provide improvements (e.g., efficiency, speed, amount of input events, and/or the like) over existing stroke input methods with respect to the input of characters because the order for inputting elements of characters need not be strictly adhered to when inputting characters. The examples for inputting characters provided above are merely exemplary as there may be other alternative examples and implementations.

Embodiments of the present application may also provide a touch screen device which may be employed in conjunction with a stylus, a pen, pencil or other pointing device that may be substituted for a dedicated instrument to function as a stylus (e.g., a finger). The keypad layout of the touch screen device may facilitate the knowledge of the position of character elements with respect to inputting characters, words, sentences, and/or the like, and as such, embodiments of the present invention may enable single-handed character input (e.g., via interactions of a finger with the touch screen). Accordingly, user experience in the input of characters (e.g., for short messages) may be enhanced.

Although exemplary embodiments of the present invention may generally be described with respect to short messages, other embodiments of the present invention may be equally applicable to text entry application such as communication applications (e.g., email, short message, word processor, web browser, electronic book, etc.), media applications (music player, etc.), gaming applications (e.g., a game player) or positional applications (e.g., user location by GPS or other methods), and/or the like. Moreover, although exemplary embodiments of the present invention may generally be described with respect to Chinese characters, other embodiments of the present invention may be equally applicable to other Asian characters, other types of complex characters, and/or the like.

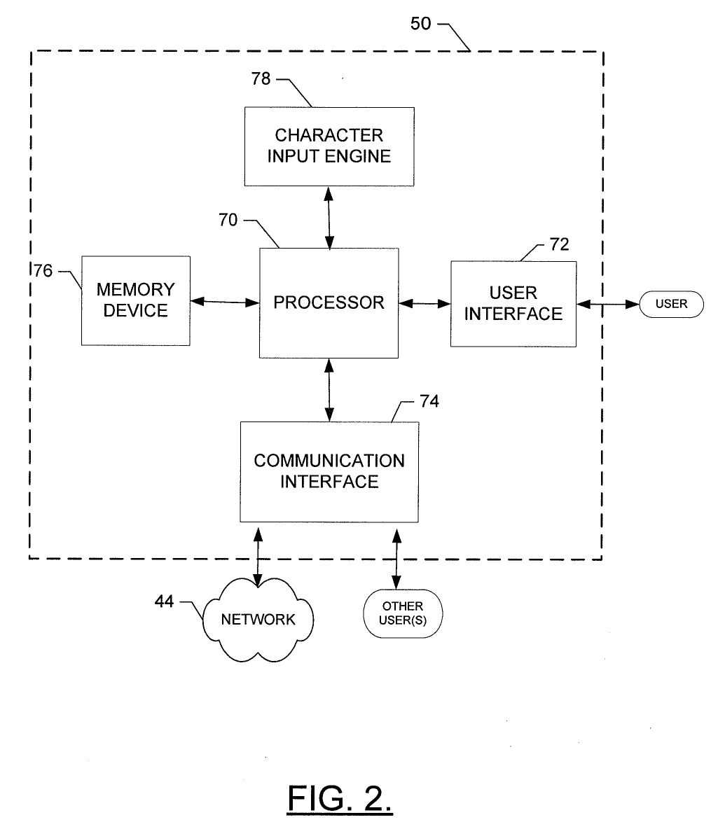

FIG. 2 illustrates a schematic block diagram of an apparatus for enabling order independent character input according to an exemplary embodiment of the present invention. An exemplary embodiment of the invention will now be described with reference to FIG. 2, in which certain elements of an apparatus 50 for enabling order independent character input are displayed. The apparatus 50 of FIG. 2 may be employed, for example, on the mobile terminal 10 of FIG. 1. However, the apparatus 50 may alternatively be embodied at a variety of other devices, both mobile and fixed (such as, for example, a network device or server). As such, while some embodiments of the present invention may be embodied wholly at a single device (e.g., the mobile terminal 10), other embodiments may be split between devices in a client/server relationship (e.g., the mobile terminal 10 and a network server). Furthermore, it should be noted that the devices or elements described below may not be mandatory and thus some may be omitted in certain embodiments. Additional elements could also be added in some cases.

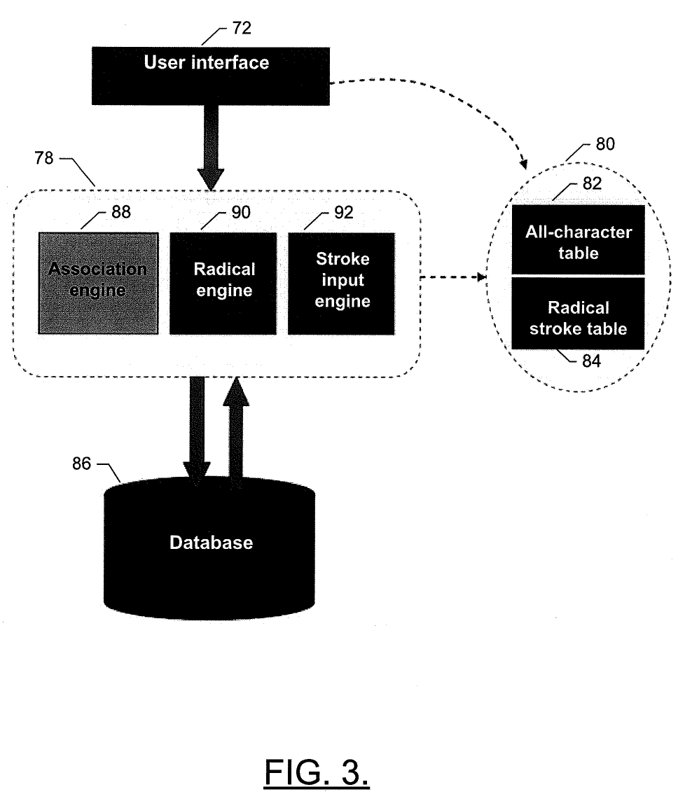

Referring now to FIG. 2, the example apparatus 50 for enabling order independent character input may include or otherwise be in communication with a processor 70 (e.g., the controller 20), a user interface 72 (e.g., display 28, keypad 30), a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 may be configured to buffer input data for processing by the processor 70. Additionally or alternatively, the memory device 76 may be configured to store instructions for execution by the processor 70. As yet another alternative, the memory device 76 may be one of a plurality of databases or tables (e.g., database 88, tables 92 and 94 of FIG. 3) that store information (e.g., one or more characters and/or one or more radicals) and/or media content. One of the databases may also store one or more identifiers in one or more tables which may serve as indexes or other means to retrieve character(s) and/or radical(s) from one or more tables.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network (e.g., network 44) and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet and/or other mechanisms.

The user interface 72 may be in communication with the processor 70 to receive an indication of a user input (e.g., one or more radicals, strokes, characters, and/or the like) at the user interface 72 and/or to provide an audible, visual (e.g., display of one or more radicals, strokes, characters, and/or the like), mechanical or other output to the user. As such, the user interface 72 may include, for example, a keyboard, a mouse, a joystick, a display, a touch screen, a microphone, a speaker, or other input/output mechanisms. In some examples, the user interface may be configured to receive one or more inputs of one or more radicals and/or strokes, and communicate the received input(s) to the character input engine 78.

In an exemplary embodiment, the processor 70 of the apparatus 50 may be embodied as, include or otherwise control a character engine 78. As such, the character engine 78 may in some cases be a separate device, module, or functional element. However, in other embodiments, the character engine 78 may be embodied within a single device, module, or functional element, such as the processor 70, the apparatus 50 or the mobile terminal 10. The character engine 78 may each be any means such as a device or circuitry embodied in hardware, software or a combination of hardware and software (e.g., processor 70 operating under software control) that is configured to perform the corresponding functions of the character engine 78, as described below. In some embodiments, communication between the character engine 78 and other elements of apparatus 50 may conducted via the processor 70. However, the character engine 78 may alternatively be in direct communication with those elements. In an exemplary embodiment, the character engine 78 may include instructions, code, modules, applications and/or circuitry for providing input order independent character input mechanism.

In some examples, the apparatus 50 may include a character list (not shown) which may include a listing of candidate characters that may be presented to the user as candidate characters by the character engine 78. The apparatus 50 may also include an input element list which may include a listing of elements (e.g., radicals and/or strokes) inputted for a character being inputted by the user, which may be arranged in their order of input (e.g., order received from the user interface). In some cases, the character list and/or the input element list may be stored on memory device (e.g., the memory device 76) accessible to the character engine 78.

The character engine 78 may be configured to provide a selection one or more candidate characters to the user interface 72 as retrieved from a database (e.g., the memory device 76) based on the entry of one or more radicals and/or strokes. In this regard, for example, the character input engine 78 may be configured to receive one or more inputs of one or more radicals and/or strokes from a user interface (e.g., from the user interface 72), for example, via a keyboard, keypad, touch screen entry, and/or the like. The character input engine 78 may in communication with a database (e.g., memory device 76), and as such, may retrieve from the database or cause the database to retrieve each candidate character(s) based at least in part on the received input(s) of radical(s) and/or stroke(s). In this regard, the character input engine 78 may retrieve from the database or cause the database to retrieve the candidate character(s) containing the received input(s). The character engine 78 may use probabilistic determinations to order the retrieved candidate character(s) in a listing of candidate character(s) presented to the user. The probabilistic determination may be based at least in part on the frequency of usage (e.g., from most frequently used to least frequently used) of each candidate character (e.g., in short messages), either generally or context specific. The character input engine 78 may also be configured to receive an input of a candidate character selected by the user from the user interface and cause an association of one or more characters (e.g., to generate a word, a phrase, and/or the like) to be generated based at least in part on the selected candidate character. In some embodiments, the character input engine 78 may include one or more engines (e.g., the association engine 88, radical engine 90, and stroke input engine 92) which may perform one or more functions of the character input engine 78 described above. The functionalities of these engines will be described in more detail below with respect to FIG. 3.

Further explanation of the operation of the character input engine 78 will now be provided in relation to FIG. 3, which illustrates an exemplary framework of an embodiment of the present invention. As shown in FIG. 3, the character engine 78 may be in communication with a user interface 72, a database 80, which may comprise an all-character table 82 and a radical stroke table 84, and a database 86. In some embodiments, one or more of the tables 82 or 84 may be included in database 88. In other embodiments, one or more of the databases 80 or 86 may be included on a single memory device (e.g., the memory device 76) accessible to the character engine 78. The all-character table 82 may be configured to store a plurality of available characters, and each character may be associated with a unique identifier or position. The radical stroke table 84 may be configured to store a plurality of available radicals, and each radical may be associated with a unique identifier or position. The database 86 may be configured to store a plurality of tables which may correspond to the plurality of available radicals stored by the radical stroke table 84, or in other words, the radicals stored in the table 84 may serve as indexes to the tables of the database 86. For example, if the radical stroke table 84 stores forty two radicals, the database 86 may correspondingly store 42 tables. In this regard, each radical stored in the table 84 may correspond to a table stored in the database 86, and each table in the database 86 may be associated with a unique identifier corresponding to the unique identifier of its corresponding radical in the table 84. For example, a table with unique identifier of 7 may correspond to the radical whose unique identifier in the table 84 is also 7. Each table of the database 86 may store an index (e.g., unique identifier) to a plurality of all available characters containing the radical corresponding to the table. In this regard, the index may correspond to the unique identifiers or positions of the characters stored in the all-character table 82. As such, the identifier of an inputted radical may be retrieved from the radical stroke table 84 and may be used to identify the corresponding table in the database 86. The indexes of all the characters containing the inputted radical may be retrieved from the identified table in the database 86 and used to retrieve the candidate characters from the all-character table 82.

In some examples, the character engine 78 may be embodied as an association engine 88, a radical engine 90 and/or a stroke input engine 92. As such, in an exemplary embodiment, the processor 70 of the apparatus 50 may be embodied as, include or otherwise control an association engine 88, a radical engine 90 and/or a stroke input engine 92. As such, the association engine 88, the radical engine 90 and/or a stroke input engine 92 may in some cases each be separate devices, modules, or functional elements. However, in other embodiments, the association engine 88, the radical engine 90 and/or a stroke input engine 92 may be embodied within a single device, module, or functional element, such as the processor 70, the apparatus 50 or the mobile terminal 10. The association engine 88, the radical engine 90 and/or a stroke input engine 92 may each be any means such as a device or circuitry embodied in hardware, software or a combination of hardware and software (e.g., processor 70 operating under software control) that is configured to perform the corresponding functions of the association engine 88, the radical engine 90 and/or a stroke input engine 92, respectively, as described below. In some embodiments, communication between the association engine 88, the radical engine 90 and/or a stroke input engine 92 may be conducted via the processor 70. However, the association engine 88, the radical engine 90 and/or a stroke input engine 92 may alternatively be in direct communication with each other.

In an exemplary embodiment, the association engine 88, the radical engine 90 and/or a stroke input engine 92 may include instructions, code, modules, applications and/or circuitry for providing word prediction and situation determining services, respectively. However, it should be noted that code, circuitry and/or instructions associated with the association engine 88, a radical engine 90 and/or a stroke input engine 92 need not necessarily be modular.

The association engine 88 may be configured to receive the selection of a candidate character from the list of candidate characters provided to the user (e.g., from the user interface 72 via a keyboard, keypad, touch screen entry, and/or the like), and determine candidate associate characters that may be associated with the character selected (e.g., to generate a word, a phrase, and/or the like). The determination of candidate associate characters may be made from a plurality of available words from a database (e.g., the memory device 78). The association engine 88 may also be configured to provide the candidate associate characters to the user interface 72 for display to the user.

The radical engine 90 may be configured to receive one or more inputs of one or more radical and/or strokes (e.g., from the user interface 72 via a keyboard, keypad, touch screen entry, and/or the like). In some examples, upon receiving a radical, the radical engine 90 may retrieve the index (e.g., identifier) of the inputted radical from the radical stroke 84 and use the retrieved index to identify the corresponding table in the database 86. The radical engine 90 may retrieve from the corresponding table or cause the database 86 to retrieve the indexes of all the characters containing or comprising the inputted radical from the corresponding table, and use the retrieved indexes of the characters to retrieve from the character table 82 the actual characters. The radical engine 90 may be configured to determine whether the received radical is the first inputted element for a given character (or in other words, the only element inputted thus far). In instances where the radical is determined to be the first input, the radical may be used to retrieve candidate characters and add them a listing of candidate characters. In instances where the radical is determined to be subsequent to one or more previously inputted characters, the radical may be used to retrieve candidate characters and update a listing of candidate characters to remove all the characters not including all the elements inputted thus far. As such, in some instances, the received radical may be the first inputted element for the character. As such, the radical engine 90 may be configured to generate a listing (e.g., a selection) of candidate characters based on the characters retrieved from the character table 82. The radical engine may cause the selection of candidate characters to be ordered in the order of decreasing frequency of usage, and may communicate the ordered selection of candidate characters to the user interface. In one example, the radical engine 90 may also cause the received radical to be included in an input element list and cause the selection of candidate characters to be included in a character list. If, the received radical is not be the first inputted element and a character list exists (based the previously received elements (e.g., radical(s), stroke(s))), the radical engine 90 may be configured to updated the existing selection of candidate characters by comparing the retrieved candidate characters with the existing list of candidate characters currently provided to the user (e.g., from the character list). In this regard, the radical engine may remove from the existing list of candidate characters, the candidate characters not containing the retrieved candidate characters, thereby effectively removing the character(s) that contained the previous elements (e.g., radical(s), stroke(s)) but do not contain the most recently received radical. The radical engine 90 may thus store the intersection between the two sets of candidate characters in the character list and cause the updated selection of candidate characters (e.g., ordered by frequency) to be communicated to the user interface.

In instances where the received radical may not be the first inputted element, one or more strokes may have been previously received. In some examples, the one or more strokes may be received by the stroke engine 92 and processed as discussed below. In this regard, the radical engine 90 may be configured to retrieve all the candidate characters from the character table 84, and separate or otherwise break up each retrieved character based on the stroke(s) constituting the character. The radical engine 90 may be configured to identify the one or more prior strokes (e.g., preceding the radical), for example, by accessing the input element list, and identifying the candidate characters whose strokes correspond the one or more prior strokes, based on the order of the one or more prior strokes. The radical engine 90 may be configured to update the selection of candidate characters with the identified candidate characters by removing the candidate characters that were not identified. The radical engine 90 may be configured to store the updated selection of candidate characters in the character list and cause the updated selection of candidate characters (e.g., ordered by frequency) to be communicated to the user interface. In other instances, the radical engine 90 may be configured to receive one or more strokes after receiving one or more radicals. As such, the radical engine 90 may be configured to compare the received stroke(s) with each character of the existing selection of candidate characters to identify one or more characters which may contain the received strokes. In this regard, the radical engine 90 may be configured to compare the received stroke(s) with portions (e.g., strokes) of each character which do not include any previously received radical(s) or stroke(s). The radical engine 90 may update the selection of candidate characters by removing the candidates not including the received stroke(s). For each subsequently received radical, the radical engine 90 may be configured to search the existing selection of candidate characters to identify the character(s) including the subsequently received radical. The radical engine may be configured to separate or otherwise break up each identified character (e.g., based on the stroke(s) constituting the character) and identify the characters including any stroke between the received radical and a first previously received radical (e.g., the first radical inputted by the user for the current character).

Although embodiments of the previous invention may operate as described above without consideration of the order in which the elements (e.g., radical(s), stroke(s), etc.) are received, other embodiments as described below may also take into account the order in which the elements are entered, and the database may not just store characters, but also information indicating the order of the elements that form the characters. The stroke engine 92 may be configured to receive one or more inputs of strokes (e.g., from the user interface 72 via a keyboard, keypad, touch screen entry, and/or the like). In some examples, the stroke engine 92 may be configured to access the input element list and add the received one or more strokes to the list. The stroke engine may be configured to retrieve from the character table 82 or cause the character table 82 to retrieve one or more candidate characters based at least in part on the inputted stroke(s). For example, the stroke engine 92 may be configured to compare the received input(s) with the characters in the table 82, and retrieve the characters including the inputted stroke(s) in the order of the inputted stroke(s). For instance, the stroke engine 92 may receive first and second stroke inputs and retrieve the characters whose first and second strokes match the received first and second strokes. The stroke engine 92 may also be configured to generate and/or modify a selection of candidate characters based at least in part on the retrieved candidate characters. The stroke engine 92 may also be configured to communicate the retrieved candidate(s) to the user interface 72 for display. In some examples, the stroke engine may communicate the Unicode of the retrieved candidate(s) to the user interface.

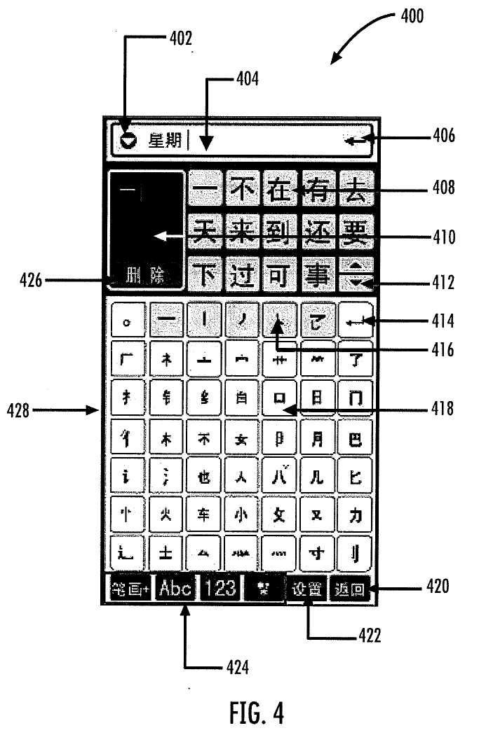

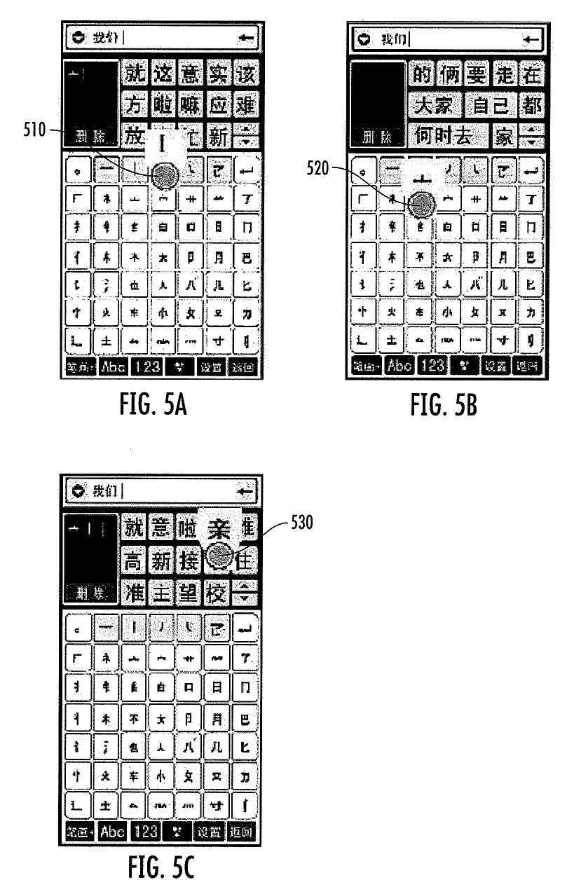

Although examples of embodiments of the present invention which may be used in connection with a touch screen display are provided with respect to FIGS. 4-5, it should be understood that embodiments of the present invention may also be employed on devices that do not employ a touch screen. In such devices, inputs and selections may be made similarly except that inputs and the selection of a particular candidate (or a word) may be made using a keyboard, a scrolling device, mouse, or other input or selection mechanism.

In this regard, and referring now to FIG. 4, an example of a user interface display 400 for providing an input order independent character input mechanism for inputting Chinese characters in accordance with an exemplary embodiment of the present invention is illustrated. In this regard, for example, the display 400 may include an extended button 402 and input context field 404, which may display one or more characters inputted by the user thus far. The display 400 may also include a backspace button 406, and a candidate list area 408 which may display a selection of candidate characters. The candidate characters may be ordered by decreasing frequency of usage, generally or in a current context. The display 400 may also include a display area 410, which may display one or more elements (e.g., radical(s) and/or stroke(s)) inputted thus far by the user, and a delete button 426. The display 400 may further include a scroll button 412 which may be used to scroll through the selection of candidate characters, and a return button 414. The display 400 may also include a keypad area 428 which may comprise a radical input area 418 and a stroke input area 416. Although the example of the display 400 may provide the keypad area 428 comprising a plurality of keys arranged in a square shape, the keypad area 428 may be arranged in a variety of additional geometric shapes (e.g., rectangular, triangular, circular, and/or the like). Each key may be configured to provide a function associated with an element (e.g., radical(s), stroke(s)) corresponding to a portion of a character. At any given time, one or more of the keys may be deactivated based on the element(s) inputted thus far, which may be displayed in display area 410. In this regard, the key(s) corresponding to elements which may not be combined with the element(s) inputted thus far to input possible character(s) may be deactivated. As such, any touch event may not be registered from the interactions with the key(s).

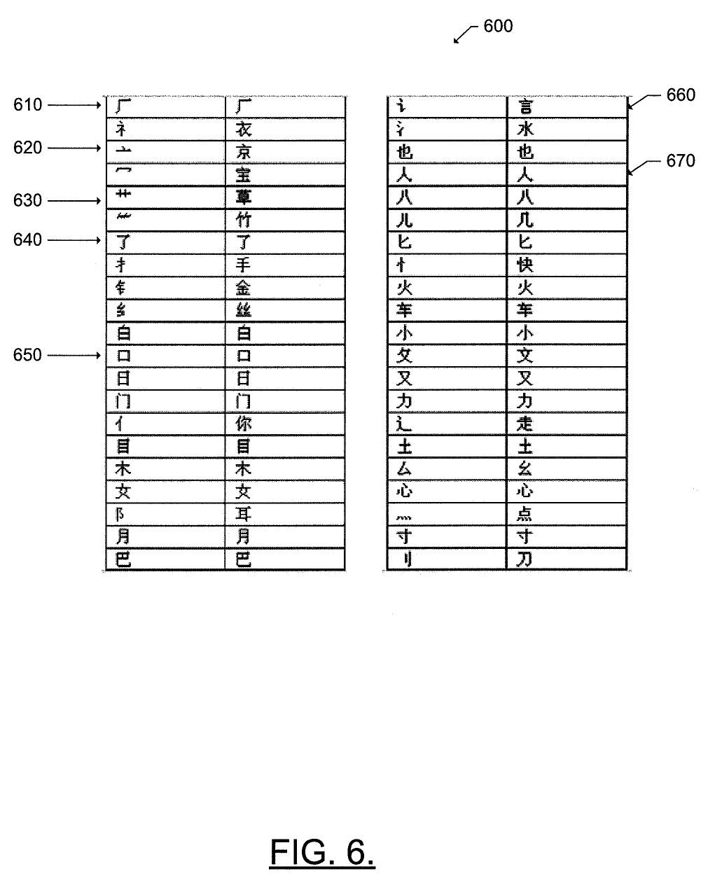

The stroke input area 416 may comprise a plurality of keys (e.g., five keys), each may correspond to one of a plurality of available strokes. The radical input area 418 may comprise a plurality of keys (e.g., forty two keys) which may correspond to a plurality of available radicals. The positions of radicals in the radical input area 418 may be arranged according to the regular position of the radical with respect to the characters (e.g., radicals usually placed on the top of characters may be placed in the top portion of the radical area 418, radicals usually placed at the bottom of characters may be placed in the bottom portion). Moreover, one or more radicals, which may be similar to one another, may share the same roots (e.g., semantic root). As such, in some examples, radicals sharing the same roots may share the same keys. Additionally, one or more radicals, which may be similar to one another, may be grouped next to each other. As such, in some examples, adjacent radicals may form characters, words, or sentences. Additionally, the corner keys of the radical input area 418 may be configured to correspond to the radicals with similar or approximately similar shapes (e.g., corner shapes). For example, the upper left corner key may correspond to “ [symbol] ” radical, while the lower corner key may correspond to the “ [symbol] ” radical. Accordingly, the keypad layout of the radical input area 418 may be intuitive to the user and correlated. As such, the radical input area may provide user friendly aspects (e.g., users may no longer have to remember or memorize the order of inputting or writing the elements of a character). Additional functions may be associated with the keys of the radical input area 418 such an extended input event function (e.g., a long-press function). An exemplary embodiment of the extended input event functionality is illustrated in FIG. 6. In this regard, a long-press of a key may cause the input or activation of a root character associated with or otherwise related to the radical associated with the key. The inputted root character may thus be displayed in the display area 410. In the event the radical is not associated with or related to a root character, the long-press of the key may cause the input of radical. Referring back to FIG. 4, the display 400 may further include a back button 420, an input settings buttons 422 (e.g., to implement user preferences such as tonality of keys), and a character range buttons area 424.

FIGS. 5A-C illustrate exemplary user interface displays providing an exemplary method for an input order independent input character mechanism in accordance with an exemplary embodiment of the present invention. In this regard, FIG. 5A illustrates a first input event 510 (e.g., touch event) received at the display (e.g., via a user interface) which may correspond to the input of a radical. FIG. 5B illustrates an exemplary result of the first input event (e.g., a radical). In this regard, all the characters which contain the first inputted radical may be provided for display in the candidate list area 408. Subsequently, a second input event 520 may also be received at the display which may correspond to the input of a stroke. FIG. 5C illustrates an exemplary result of the second input event (e.g., a stroke). In this regard, all the candidate list area 408 may be updated to remove all the characters not containing the inputted stroke. Subsequently, a third input event 530 may also be received at the display which may correspond to the selection of a candidate character for the candidate list area 408.

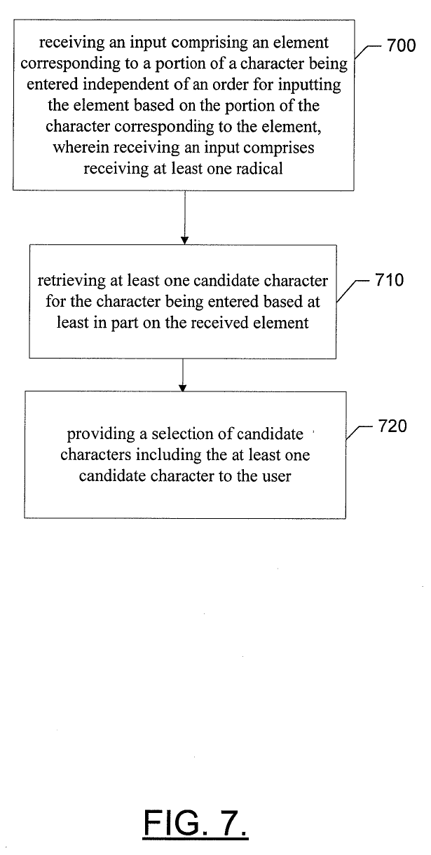

FIG. 7 is a flowchart of a system, method and program product according to exemplary embodiments of the invention. It will be understood that each block or step of the flowchart, and combinations of blocks in the flowchart, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal (or a network device) and executed by a built-in processor in the mobile terminal (e.g., the processor 70) (or a network device). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart may support combinations of means for performing the specified functions, combinations of steps for performing the specified functions and program instruction means for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer instructions.

In this regard, one embodiment of a method for providing an input order independent input character mechanism as illustrated, for example, in FIG. 7 may include receiving an input comprising an element corresponding to a portion of a character being entered independent of an order for inputting the element based on the portion of the character corresponding to the element, wherein receiving an input comprises receiving at least one radical at operation 700, retrieving at least one candidate character for the character being entered based at least in part on the received element at operation 710, and providing a selection of candidate characters including the at least one candidate character to the user at operation 720.

In some embodiments, the method may include further optional operations, some examples of which are shown in dashed lines in FIG. 7. Optional operations may be performed in any order and/or in various combinations with each other and the other operations in various alternative embodiments. As such, retrieving at least one candidate character for the character being entered at operation 710 may include retrieving at least one candidate character containing the element. In some examples, the method may further include receiving a user selection of a candidate character from the selection of candidate characters corresponding to the character being entered. In other examples, the method also include updating the selection of candidate characters based at least in part on a type of the received element, wherein a type of a received element comprises at least one of a radical or a stroke. In some instances, the method may additionally comparing the at least one candidate character to the selection of candidate characters to remove at least one character from to the selection of candidate characters based at least in part on the least one candidate character. In other examples, the method may further include further comprising receiving an input comprising an element corresponding to a different portion of the character being entered independent of an order for inputting the element based on the different portion of the character corresponding to the element. In some situations, receiving an input comprising an element corresponding to the different portion of the character being entered independent of an order for inputting the element based on the portion of the character corresponding to the element may include receiving at least one stroke. The method may additionally include comprising identifying a character containing the received at least one stroke from the selection of candidate characters.

In an exemplary embodiment, an apparatus for performing the method of FIG. 7 above may comprise a processor (e.g., the processor 70) configured to perform some or each of the operations (600-620) described above. The processor may, for example, be configured to perform the operations (600-620) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 600-620 may comprise, for example, the processor 70, the character engine 78 (which may include the association engine 88, the radical engine 80 and/or the stroke input engine 92), and/or an algorithm executed by the processor 70 for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an input comprising an element corresponding to a portion of a character being entered by a user independent of an order for inputting the element based on the portion of the character corresponding to the element, wherein receiving an input comprises receiving at least one radical;
retrieving at least one candidate character for the character being entered based at least in part on the received element; and
providing a selection of candidate characters including the at least one candidate character to the user.

2. The method of claim 1, wherein retrieving at least one candidate character for the character being entered comprises retrieving at least one candidate character containing the element.

3. The method of claim 1, further comprising updating the selection of candidate characters based at least in part on a type of the received element, wherein a type of a received element comprises at least one of a radical or a stroke.

4. The method of claim 3, further comprising comparing the at least one candidate character to the selection of candidate characters to remove at least one character from to the selection of candidate characters based at least in part on the least one candidate character.

5. The method of claim 1, further comprising receiving an input comprising an element corresponding to a different portion of the character being entered independent of an order for inputting the element based on the different portion of the character corresponding to the element.

6. The method of claim 5, wherein receiving an input comprising an element corresponding to the different portion of the character being entered independent of an order for inputting the element based on the different portion of the character corresponding to the element comprises receiving at least one stroke.

7. The method of claim 6, further comprising identifying a character containing the received at least one stroke from the selection of candidate characters.

8. The method of claim 1, further comprising receiving a user selection of a candidate character from the selection of candidate characters corresponding to the character being entered.

9. A computer program product comprising at least one computer-readable storage medium having computer-executable program code instructions stored therein, the computer-executable program code instruction comprising:
program code instructions for receiving an input comprising an element corresponding to a portion of a character being entered by a user independent of an order for inputting the element based on the portion of the character corresponding to the element, wherein receiving an input comprises receiving at least one radical;
program code instructions for retrieving at least one candidate character for the character being entered based at least in part on the received element; and
program code instructions for providing a selection of candidate characters including the at least one candidate character to the user.

10. The computer program product of claim 9, wherein program code instructions for retrieving at least one candidate character for the character being entered include instructions for retrieving at least one candidate character containing the element.

11. The computer program product of claim 9, further comprising program code instructions for updating the selection of candidate characters based at least in part on a type of the received element, wherein a type of a received element comprises at least one of a radical or a stroke.

12. The computer program product of claim 11, further comprising program code instructions for comparing the at least one candidate character to the selection of candidate characters to remove at least one character from to the selection of candidate characters based at least in part on the least one candidate character.

13. The computer program product of claim 9, further comprising program code portions for further comprising receiving an input comprising an element corresponding to a different portion of the character being entered independent of an order for inputting the element based on the different portion of the character corresponding to the element.

14. The computer program product of claim 13, wherein program code portions for receiving an input comprising an element corresponding to the different portion of the character being entered independent of an order for inputting the element based on the portion of the character corresponding to the element comprises receiving at least one stroke.

15. The computer program product of claim 14, further comprising program code instructions for identifying a character containing the received at least one stroke from the selection of candidate characters.

16. The computer program product of claim 9, further comprising program code for receiving a user selection of a candidate character from the selection of candidate characters corresponding to the character being entered.

17. An apparatus comprising a processor configured to:
receive an input comprising an element corresponding to a portion of a character being entered independent of an order for inputting the element based on the portion of the character corresponding to the element, wherein the processor is configured to receive an input by receiving at least one radical;
retrieve at least one candidate character for the character being entered based at least in part on the received element; and
provide a selection of candidate characters including the at least one candidate character to the user.

18. The apparatus of claim 17, wherein the processor is configured to retrieve at least one candidate character for the character being entered by retrieving at least one candidate character containing the element.

19. The apparatus of claim 18, wherein the processor is further configured to update the selection of candidate characters based at least in part on a type of the received element, wherein a type of a received element comprises at least one of a radical or a stroke.

20. The apparatus of claim 17, wherein the processor is further configured to compare the at least one candidate character to the selection of candidate characters to remove at least one character from to the selection of candidate characters based at least in part on the least one candidate character.

21. The apparatus of claim 20, wherein the processor is further configured to receive an input comprising an element corresponding to a different portion of the character being entered independent of an order for inputting the element based on the different portion of the character corresponding to the element.

22. The apparatus of claim 21, wherein the processor is further configured to receive an input comprising an element corresponding to the different portion of the character being entered independent of an order for inputting the element based on the portion of the character corresponding to the element comprises receiving at least one stroke.

23. The apparatus of claim 22, wherein the processor is further configured to identify a character containing the received at least one stroke from the selection of candidate characters.

24. The apparatus of claim 17, wherein the processor is further configured to receiving a user selection of a candidate character from the selection of candidate characters corresponding to the character being entered.

25. A user interface generated in accordance with instructions stored in a computer readable storage medium, the user interface comprising:
a keypad configured to define a geometric shape and provide a grouping of keys, wherein the keypad comprises a plurality of keys, wherein each key is configured provide a function associated with an element corresponding to a portion of a character, and wherein the grouping of keys are based at least in part on the function associated with the element corresponding to the portion of a character.

26. The user interface of claim 25, wherein adjacent keys of the keypad form at least one of a character, a word, or a sentence.
